(19) United States
(12) Patent Application Publication
(10) Pub. No.: US 2006/0080725 A1
(43) Pub. Date: Apr. 13, 2006

(54) Systems and methods for recording digital media content

(75) Inventor: Toni Paila, Degerby (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 10/962,463

(22) Filed: Oct. 13, 2004

(51) Int. Cl. H04N 7/16; H04N 7/173

(52) U.S. Cl. 725/135; 725/100; 725/131

(57) ABSTRACT

Methods and systems for automatic recording of digital media content of a main service when a sub-service is accessed are described. The method for recording comprises steps of receiving digital media content of a main service, receiving a sub-service signal indicating a request to access a sub-service, accessing the sub-service, initiating automatic recording of the digital media content of the main service, receiving a main service signal indicating a request to return to the main service, and accessing the main service in response to the request to return. The system may include a receiver, a transceiver, a memory, a processor, and a rendering component. The methods and system may be implemented within an electronic device, such as a mobile device or a set-top terminal.

### FIELD OF THE INVENTION

The invention relates generally to a system and method for recording digital media content. More specifically, the invention provides a method and system for automatically recording digital media content of a main service when a sub-service is accessed.

### BACKGROUND OF THE INVENTION

Personal video recorders (PVRs), also known as digital video recorders (DVRs), have become popular devices in homes. With a PVR, a user can record a television program that has been broadcast and then perform various functions. For example, under a conventional PVR, a user can watch a live sporting event and press a pause button during the event to answer a phone or the door, get a drink, or even leave for an errand. Upon return, the user can then start the event from the time it was paused. The user can even rewind the event or fast forward up to the current live point. Therefore, a user has control to watch an instant reply on a sporting event, hear a favorite song again during a concert event, or listen to a phrase again during a live debate or speech.

Many terminal set-top boxes have been developed to include this capability, such as the Series 2 Digital Video Recorder box by TiVo®, Inc. of Alviso, Calif. With a DVR by TiVo®, a user can schedule a certain television program to be recorded. For example, a user can record a soccer game being broadcast on a certain station. A tuner connected to the DVR receives the broadcast soccer game and the DVR records the soccer game. A user can watch the soccer game at any time during or after recording. As the user is watching the game, she can rewind to instantly replay a certain moment in the game. Alternatively, if the user misses the first half of the game, the user can start watching the game from the beginning while the DVR continues to record the live/current broadcast. The user can fast forward to skip commercials or halftime and/or start watching from the live/current broadcast.

However, conventional systems fail to allow a user to automatically record content when the user accesses another service. Under a conventional system, a user must perform an operation to start recording the service. A user must explicitly command the set-top box to pause a live program initiating a recordation of the program. Further, conventional systems do not allow a user to access a sub-service while the main service is being broadcast and recorded. For example, if the main service is digital media content, such as a television being broadcast, a user can not switch to access a sub-service and have the system continue to record the main service.

### BRIEF SUMMARY OF THE INVENTION

According to aspects of the invention, a method for automatically recording digital media content comprises steps of receiving digital media content of a main service, receiving a sub-service signal indicating a request to access a sub-service, accessing the sub-service, initiating automatic recording of the digital media content of the main service, receiving a main service signal indicating a request to return to the main service, and accessing the main service in response to the request to return. The main service may be a television program service and the sub-service may be an Internet browser application.

Another aspect of the invention provides a system for automatically recording digital media content, the system comprising a receiver configured to receive digital media content of a main service, a transceiver, coupled to a processor, the transceiver configured to receive data associated with a sub-service, a memory, coupled to the receiver and the processor, the memory configured to automatically record the digital media content of the main service when the sub-service is accessed, the processor configured to receive a first command to access the sub-service and a second command to access the main service, and rendering means configured to render one or more components of the digital media content of the main service and the data associated with the sub-service. Aspects of the system may be included within or include a set-top terminal or a mobile electronic device.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a block diagram of an illustrative system for automatically recording digital media content in accordance with at least one aspect of the present invention;

FIG. 2 is an illustrative time graph showing recordation and consumption of services in accordance with at least one aspect of the present invention;

FIG. 3 is an illustrative time graph showing buffer content over time when recording a service in accordance with at least one aspect of the present invention;

FIG. 4 is another illustrative time graph showing buffer content over time when recording a service in accordance with at least one aspect of the present invention;

FIGS. 5A and 5B are block diagrams of an illustrative system for automatically recording digital media content in accordance with at least one aspect of the present invention;

FIG. 5C is an illustrative time graph showing recordation and consumption of services with reference to FIGS. 5A and 5B in accordance with at least one aspect of the present invention;

FIG. 6 is a block diagram of an illustrative mobile device in accordance with at least one aspect of the present invention; and

FIG. 7 is a flow chart illustrating an example method for automatically recording digital media content of a main service upon accessing a sub-service in accordance with at least one aspect of the present invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

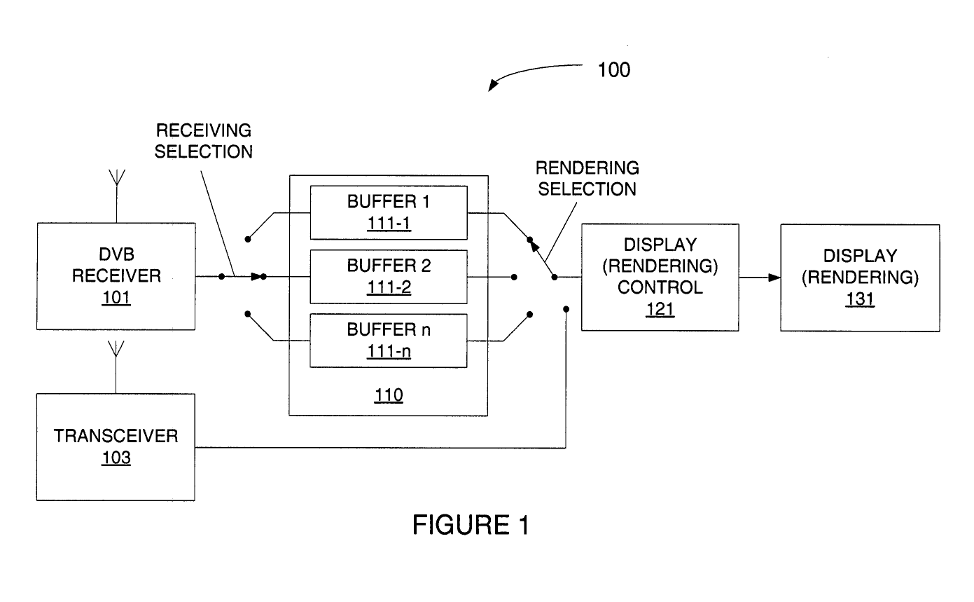

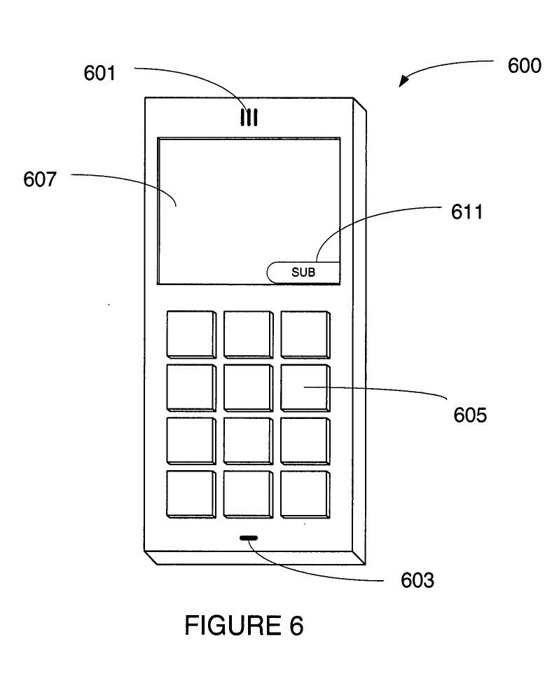

FIG. 1 illustrates a block diagram of an illustrative system 100 for automatically recording digital media content in accordance with at least one aspect of the present invention. System 100 may be included within a mobile device, such as mobile device 600 shown in FIG. 6. As used herein, the terms “automatically” and “automatic” include actions that are transparent to a user, actions that are initiated in response to an indirect action of a user to initiate the actions, and/or a combination of these two.

As shown in FIG. 1, system 100 includes a digital broadcast receiver 101 and a transceiver 103. Transceiver 103 is configured to allow for Internet browsing. Digital broadcast receiver 101 is configured to receive digital broadcast transmissions, such as the European system DVB, the United States system ATSC, and the Japanese system ISDB-T. Types of digital broadcast transmissions include a time-sliced digital video broadcast. One type of DVB transmission is Digital video broadcasting-handheld (DVB-H), a recently developed technology that increases the capabilities and services available on small handheld devices, such as mobile telephones. The DVB-H is designed to deliver 10 Mbps of data to a battery-powered terminal device. Digital broadcast receiver 101 may be configured to receive digital video broadcast-handheld (DVB-H) transmissions that use timeslicing. Transceiver 103 may allow for bidirectional communication, which may be, e.g., Internet browsing using General Packet Radio Service (GPRS) or other data transfer means.

A buffer system 110 is shown to include a number of buffers 111-1-111-n. A switch between receiver 101 and the buffer system 110 allows for data received from the receiver 101 to be stored in various buffers 111-1-111-n. The output of the buffers 111-1-111-n and transceiver 103 are shown connected to a display (rendering) control 121 through a rendering selection switch. Data is then sent to the rendering means, e.g., the display 131.

While using the system 100, a user may select the service, e.g., television program, which she wants to view. In a timeslicing environment, the received bursts of data are loaded into a buffer system 110 before rendering the service, e.g. on a display 131. System 100 is shown to include a plurality of buffers 111-1-111-n, which are used for buffering data from different received services. Alternatively the size of one buffer 111-1 is such that data from a number of services may be buffered in that buffer. The user may select which of the services is rendered, e.g., displayed. During the rendering, e.g., display of one service, the data from other selected services may be buffered. The user may select which service or which of the available services are stored in said one 111-1 or more buffers. In accordance with at least one aspect of the present invention, the buffering, i.e., storing, of data is done automatically. In this case, the main service, such as a television program, which the user was viewing is automatically recorded when the user changes to a sub-service, such as browsing the Internet.

One way of broadcasting data is to use an IP datacasting (IPDC) network. IPDC is a combination of digital broadcast and Internet Protocol. Through such an IP-based broadcasting network, one or more service providers can supply different types of IP services including on-line newspapers, radio, and television. These IP services are organized into one or more media streams in the form of audio, video and/or other types of data. In an IPDC network using timeslicing, the different services may be transmitted as data bursts at the same frequency. Each of the services is identifiable and each has a transmitting schedule, wherein the time for the next data burst for the service is announced with a parameter delta-t. In an IPDC network using timeslicing, it is thus possible to receive a plurality of services by tuning the receiver on a certain frequency.

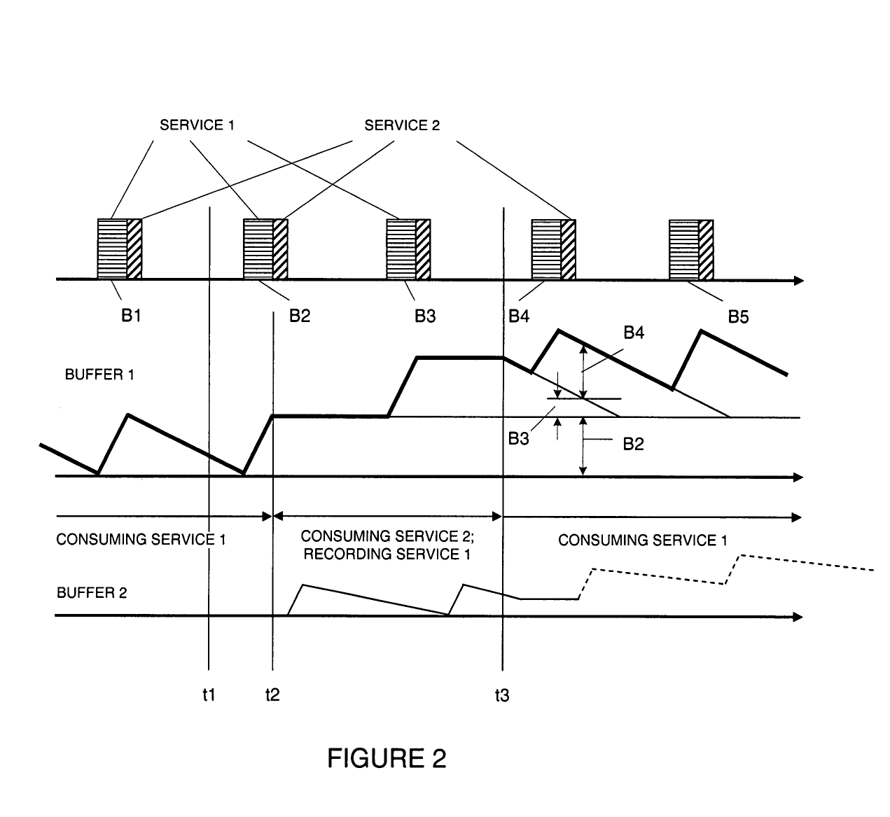

FIG. 2 is an illustrative time graph showing recordation and consumption of services in accordance with at least one aspect of the present invention. As shown, a user is consuming, e.g., watching digital media content in the form of a television program, service 1, a main service. At time t=t1, the user decides to access service 2, a sub-service. As the system has not been receiving the sub-service, the system waits until the data burst including data for the sub-service starts at t−t2. During this time between t1 and t2, the main service, service 1, continues to be rendered, e.g., displayed. Starting at time t=t2, the user is consuming the sub-service, service 2 and the data relating to the main service, service 1, is buffered, i.e., recorded. At time t=t3, the user returns to the main service, service 1, and continues consuming the main service from the point where she left the main service, e.g., time t=t2.

In accordance with at least one aspect of the present invention, the user may return to the sub-service, service 2, at a later point in time, where the data relating to the sub-service is buffered, shown in FIG. 2 by a dotted line. The user also may terminate the sub-service, wherein Buffer 2 may be emptied, e.g., by deleting the contents of the buffer. In such a case, Buffer 2 may be overwritten with other data from another service.

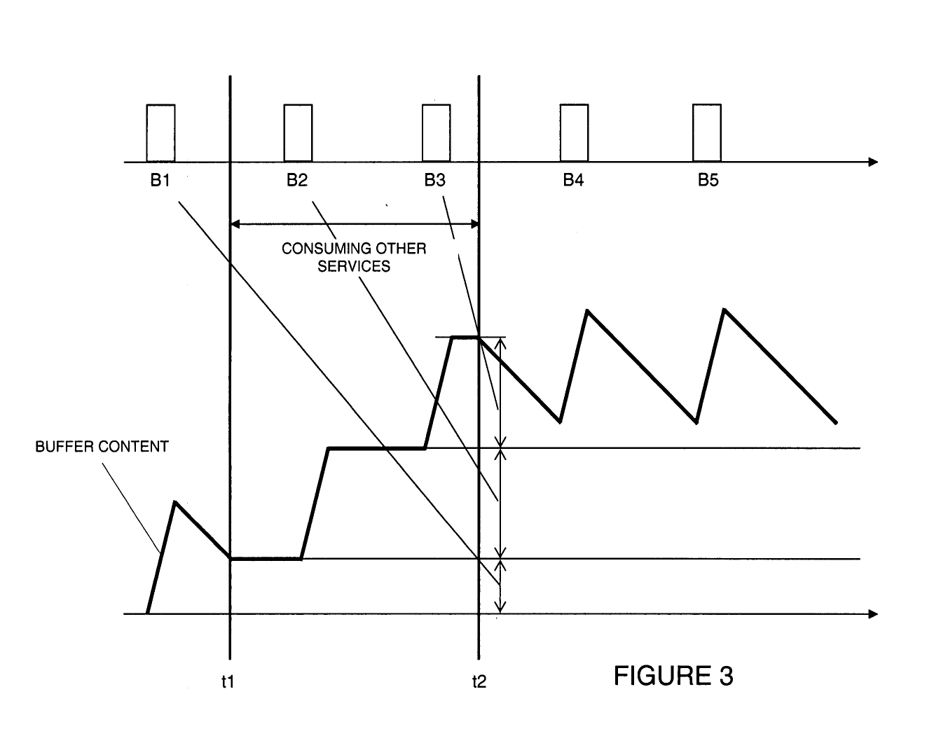

FIG. 3 is an illustrative time graph showing buffer content over time when recording a service in accordance with at least one aspect of the present invention. As shown, prior to time t=t1, a user is consuming a main service. At time t=t1, the user begins consuming other service(s), and the buffer unloading of the content of data burst B1 stops. During the time of consumption of other services, the buffer is loaded with the contents of data bursts B2 and B3.

When the user returns to the main service at time t=t2, the buffer contains data from data bursts B1, B2, and B3. All the data from the most recent bursts B3 and B2 are stored in the buffer. In addition, data from data burst B1 which has not yet been shown/rendered from when the user switched to the sub-service also is stored in the buffer. If an overflow of the buffer occurs, there are configurable options as to which data is discarded. For example, in one option, the oldest data may be discarded. For another example, user preferences may be employed to determine the data to be discarded, such as to discard news type data, but maintain sports type data. The data can be coded and/or tagged in some manner to distinguish by type, thereby allowing a user to categorize her preference by the type.

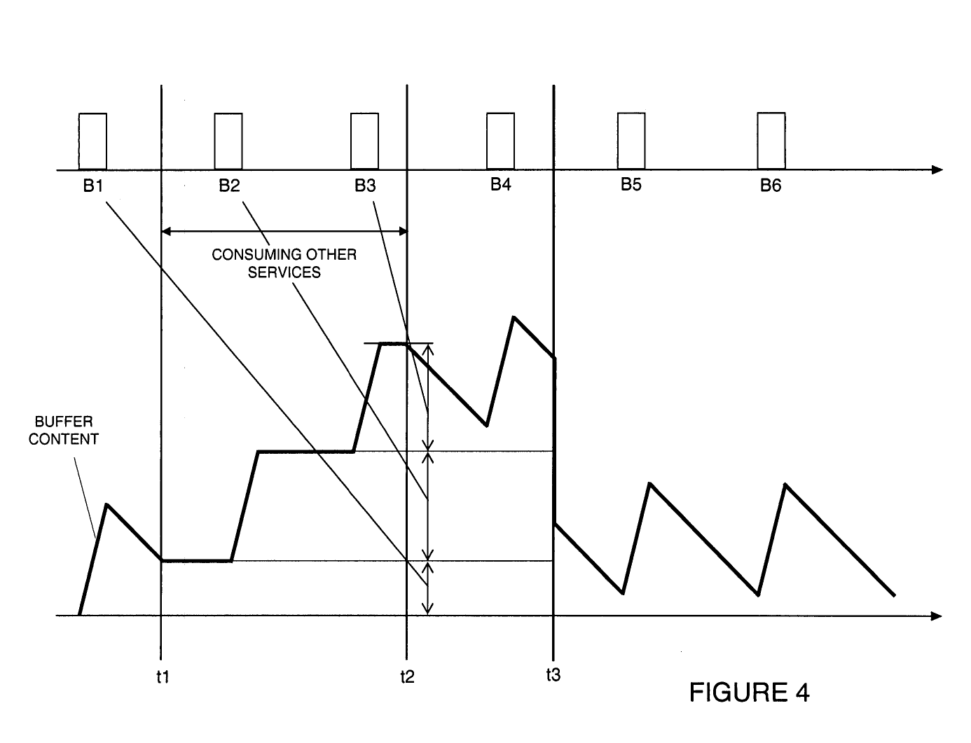

FIG. 4 is another illustrative time graph showing buffer content over time when recording a service in accordance with at least one aspect of the present invention. As shown, when a user returns at time t=t2 to a main service, she is able return to that point in the television program from where she left to access the sub-service or she is able to start consuming the main service from any point between time t=t1 and time t=t2. The user may keep the data from the recorded data bursts in the buffer if the capacity of the buffer allows it or she may delete or discard some parts of the recorded data.

As shown in FIG. 4, a user may decide to delete from the buffer the data from the earlier bursts B1 and B2 at time t=t3. At that time, the data from bursts B3 and B4 are in the buffer. If the user was consuming data from the oldest part, data burst B1, she may jump to the contents of data burst B3. If the user was consuming data from burst B3, no or almost no change may be detected.

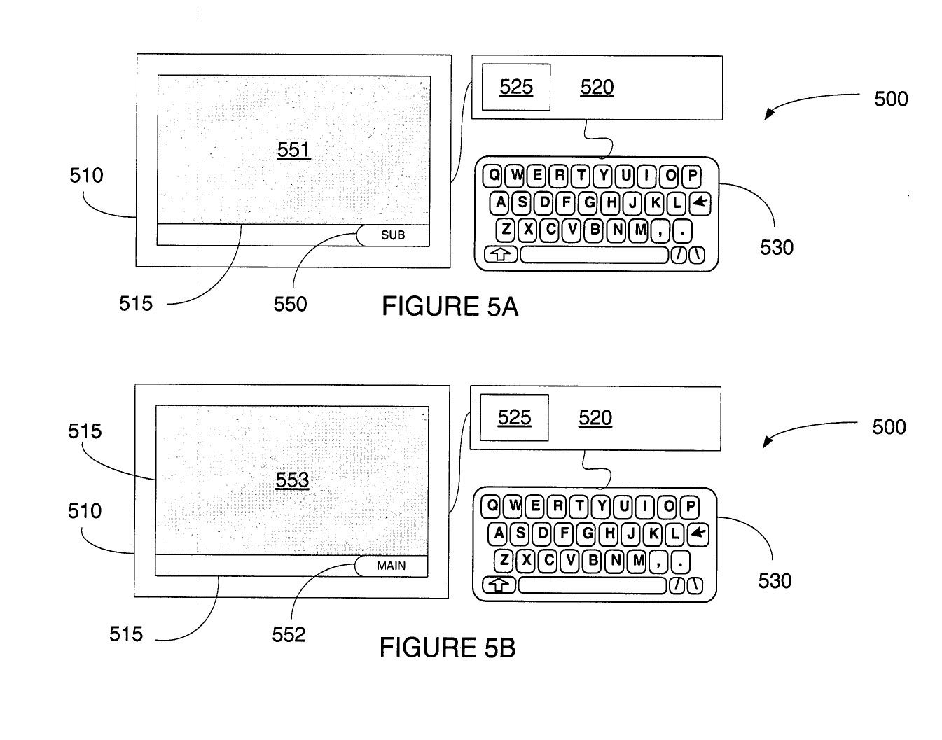

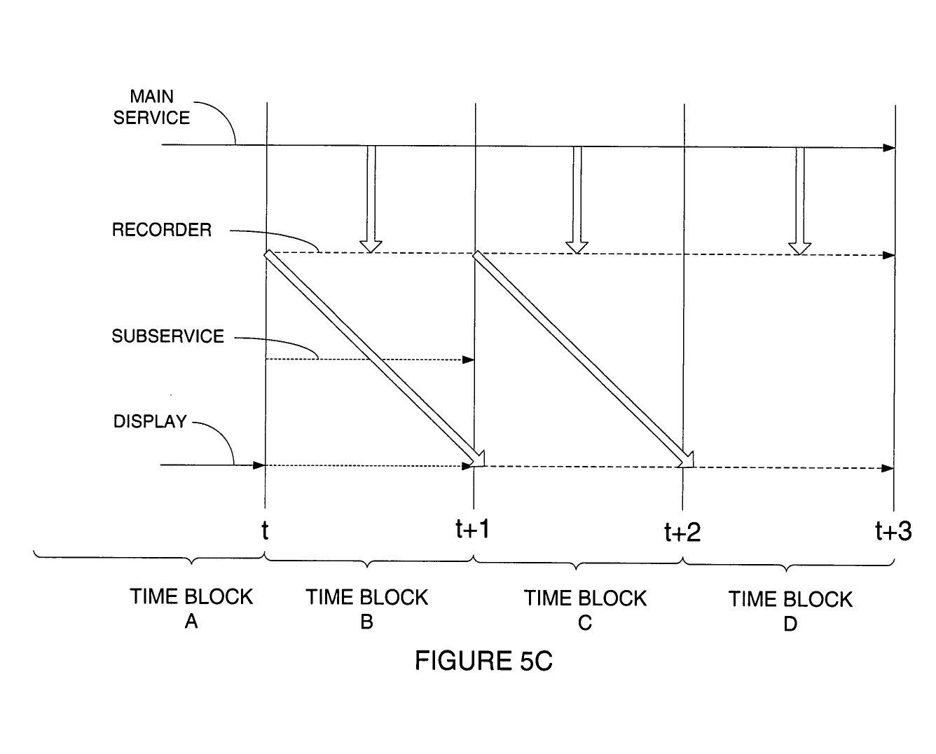

FIGS. 5A and 5B are block diagrams of an illustrative system for automatically recording digital media content, such as a television program, in accordance with at least one aspect of the present invention. FIG. 5C is an illustrative time graph showing recordation and consumption of services with reference to FIGS. 5A and 5B in accordance with at least one aspect of the present invention. Digital media content may be included within a time-sliced digital video broadcast. FIGS. 5A and 5B show a recordation system 500. Recordation system 500 includes rendering means, e.g., a monitor/display component 510 that includes a display area 515. Display component 510 may be a television or a mobile device, such as a personal digital assistant and/or a mobile phone. Display component 510 is shown coupled to a processor component 520. Processor component 520 may be a set-top box. It should be understood that the term coupled may include hardware, software, and/or firmware components and any connection may be direct or indirect through other components. The connection may be wired, wireless, or a combination of the two. Further, processor component 520 may be included within a mobile device and/or television with the display component 510. As shown, processor component 520 includes a memory 525. Memory 525 may be used to record digital media content of a main service while a user is accessing a sub-service as described herein. Although shown within processor component 520, memory 525 may be external to processor component 520. The digital media content of the main service may be streaming digital content.

Also coupled to processor component 520 is an input device 530. Input device 530 is shown to be a keyboard type input device, but it should be understood by those skilled in the art that any number of different input devices 530 may be included within recordation system 500. Other input devices 530 that may be included are a touchpad, a mouse, a joystick, a numeric keypad, and a microphone for capturing voice commands, among other devices. Further, processor component 520 and input device 530 may be included within a mobile device and/or television with the display component 510.

As shown in FIG. 5A, display area 515 includes an active main service area 551 and a sub-service indicium, such as sub-service icon 550. Main service area 551 is active when a user is utilizing/accessing the main service. For example, a main service may be a television program service and/or other form of digital media content service. Sub-service icon 550 is an illustrative example of an access object to a sub-service. Sub-service icon 550 may be associated with a web link or similar access object that appears in the digital media content, such as in the picture of the television program, next to the picture, as shown in FIG. 5A, and/or in some other area. The sub-service may be a web browser, an interactive gaming application, and/or an electronic mail application among other applications. In FIG. 5A, a user may be watching a television program as digital media content in the main service area 551 on the display area 515. At some point, the user may desire to access a sub-service, such as a web browser. In such a case, the user may initiate the web browser, e.g., by clicking on the sub-service icon 550, to initiate the web browser. In one embodiment, the web browser may be initiated automatically without user interaction, e.g., the received broadcast may contain a trigger for opening the web browser.

As shown in FIG. 5B, the user has accessed the sub-service icon 550 initiating the sub-service, such as a web browser application. As shown, the display area 515 includes an active sub-service area 553 and a main service indicium, such as main service icon 552. Sub-service area 553 is active when the user is utilizing/accessing the sub-service. Main service icon 552 is a link or similar access object that takes the user back to the main service, such as a digital media content service including a television program. The user can switch back and forth between a main service and a sub-service and/or multiple sub-services. Main service icon 552 instead may be some type of reminder for the user of the main service as the user may use one or more keys for switching between main and sub-services. Correspondingly in FIG. 5A, sub-service icon 550 shows the selected sub-service to which the user can switch. In one embodiment the non-active service mat be shown as a small screen within the display area, e.g., like a picture-in-picture.

FIG. 5C shows a time graph of this sequence of events and operation of different components of recordation system 500. Until time t, in time block A, a user may be viewing a live television program as a main service. Display area 515 may be displaying the main service in the main service area 551. At time t, the user initiates a sub-service, such as by clicking on the sub-service icon 550 in FIG. 5A. As described above, the sub-service may be an Internet browser allowing the user to browse the Internet or an application for viewing digital content. During time block B, between time t, when the user accesses the sub-service, and time t+1, when the user accesses the main service, recordation system 500 performs some operations. For example, at time t, the user has accessed the sub-service. In response, during the time period of time block B, recordation system 500 automatically begins to record the main service while the sub-service is being displayed for the user. This is shown in FIG. 5B.

At some point t+1, the user may decide to return to the main service. However, at the time of returning, the live broadcast of the main service television program is not at the point where the user stopped viewing the main service and initiated the sub-service. Therefore, the user begins to view the television program of the main service from the point in which she accessed the sub-service. Alternatively, the user may fast forward to a different point and/or start viewing the main service as a live program again, merely skipping over the portion she missed while accessing the sub-service. In the instance in which the user starts viewing the main service from the point in which she left, time t, the user views the recorded main service during time block B stored in memory 525 while the recordation system 500 continues to record the live television program of the main service during time block C. In such a case, the user is viewing the digital media content of time block B during the time period of time block C and the recordation system 500 continues to record the main service of time block C. The same sequence of events occurs at time t+2. The user may fast forward at any point up to the live television program and/or may view content recorded from an earlier time block during a later time block while the recordation system 500 records the current time block content.

FIG. 6 is a block diagram of an illustrative mobile device 600 in accordance with at least one aspect of the present invention. As described herein, aspects of the present invention may be included within a mobile device, such as a personal digital assistant and/or a mobile telephone. Mobile device 600 is shown to include a speaker 601 and a microphone 603. Microphone 603 is one type of input device that may be used to input commands for accessing a main service or a sub-service. Keypad 605 may also be used as an input device for inputting commands. Alternatively, although not shown, a keyboard may be attached, in a wired, wireless, or combination of the two, to mobile device 600 for inputting commands. Mobile device 600 also includes a rendering component, e.g., display 607, for rendering one or more components of the digital media content. A sub-service icon 611, similar to sub-service icon 550 is also shown. As shown, the entire recordation system in accordance with aspects of the present invention may be included within a mobile device 600.

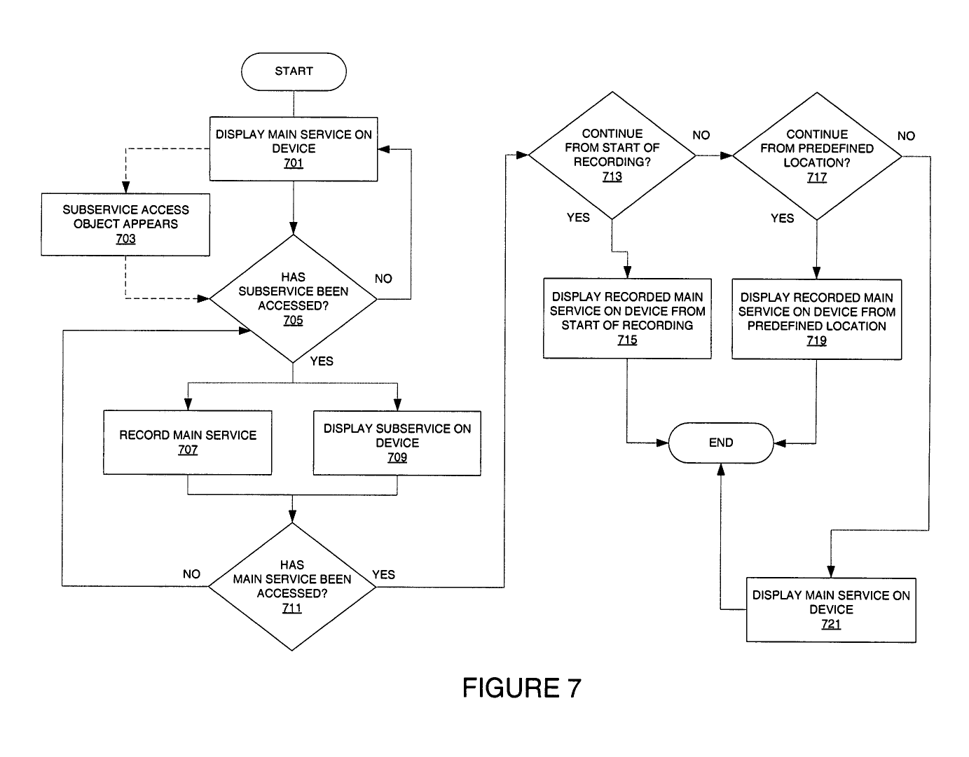

FIG. 7 is a flow chart illustrating an example method for automatically recording digital media content of a main service upon accessing a sub-service in accordance with at least one aspect of the present invention. The process begins and at step 701, a main service is rendered, e.g., displayed, on an electronic device. As described herein, the main service may be a live television program. In accordance with at least one aspect of the present invention, the process proceeds to step 703 where a sub-service access object appears on the display of the electronic device. The sub-service access object may be the sub-service icon 550 as shown in FIG. 5A.

From either step 701 or step 703, the process proceeds to step 705 where a determination is made as to whether a sub-service has been accessed by a user. If the sub-service has not been accessed, the process returns to step 701, else the process proceeds to steps 707 and 709. Steps 707 and 709 may occur concurrently or simultaneously. At step 707, the recordation system records the main service. At step 709, the sub-service is rendered, e.g., displayed, on the electronic device. At step 711, a determination is made as to whether the main service has been accessed, such as when the user returns to viewing digital media content, such as a television program. If the main service has not been accessed, the process returns to step 705. If the main service has been accessed, the process proceeds to step 713.

At step 713, a determination is made as to whether the user desires to continue viewing the main service from the start of the recordation of the main service while the user was accessing the sub-service. If the system continues from the start of the recordation of the main service, the process proceeds to step 715 the recorded main service is rendered, e.g., displayed, on the electronic device from the start of the recording. If the main service is not shown from the point in which recordation started, at step 717, a determination is made as to whether the user desires to continue viewing the main service from a predefined location. For example, the user may desire to start from some point between the start of the recordation and the current content being broadcast. If the determination in step 717 is yes, at step 719, the recorded main service is rendered, e.g., displayed, on the electronic device from the predefined position. If the answer to step 717 is no, at step 721, the live main service program is rendered, e.g., displayed, on the electronic device.

One or more aspects of the invention may be embodied in computer-executable instructions, such as in one or more program modules, executed by one or more computers, set top boxes, mobile terminals, or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

I claim:

1. A method for automatically recording digital media content comprising steps of:
receiving digital media content of a main service;
receiving a sub-service signal indicating a request to access a sub-service;
accessing the sub-service;
initiating automatic recording of the digital media content of the main service;
receiving a main service signal indicating a request to return to the main service; and
accessing the main service in response to the request to return.

2. The method of claim 1, wherein the digital media content is a streaming digital content service.

3. The method of claim 2, wherein the streaming digital content service is a television program.

4. The method of claim 1, wherein the sub-service is a service including digital media content.

5. The method of claim 4, wherein the sub-service is a web browser application.

6. The method of claim 1, further comprising a step of rendering the digital media content with rendering means of an electronic device.

7. The method of claim 6, wherein the step of rendering the digital media content with rendering means includes displaying the digital media content on a display of the electronic device.

8. The method of claim 6, wherein the request to access the sub-service is an input received from an input device of the electronic device.

9. The method of claim 1, further comprising a step of determining whether the request to access the sub-service has been received.

10. The method of claim 1, upon receiving the main service signal, the method further comprising a step of determining whether to render the recorded digital media content of the main service from the start of the recorded digital media content and the step of accessing the main service in response to the request to return includes rendering the recorded digital media content of the main service from the start of the recorded digital media content.

11. The method of claim 1, upon receiving the main service signal, the method further comprising a step of determining whether to render the recorded digital media content of the main service from a predefined point of the recorded digital media content and the step of accessing the main service in response to the request to return includes rendering the recorded digital media content of the main service from the predefined point of the recorded digital media content.

12. A computer-readable medium storing computer-executable instructions for performing the steps recited in claim 1.

13. A system for automatically recording digital media content, the system comprising:
a receiver configured to receive digital media content of a main service;
a transceiver, coupled to a processor, the transceiver configured to receive data associated with a sub-service;
a memory, coupled to the receiver and the processor, the memory configured to automatically record the digital media content of the main service when the sub-service is accessed;
the processor configured to receive a first command to access the sub-service and a second command to access the main service; and
rendering means configured to render the digital media content of the main service and the data associated with the sub-service.

14. The system of claim 13, wherein the rendering means includes a display component configured to display the digital media content.

15. The system of claim 13, wherein the receiver is a digital video broadcast type receiver.

16. The system of claim 13, wherein the digital media content is included within a time-sliced digital video broadcast.

17. The system of claim 13, wherein the transceiver is configured to allow for bidirectional communication.

18. The system of claim 13, wherein the memory is a buffer system, the buffer system including at least a first buffer and a second buffer.

19. The system of claim 18, wherein the digital media content is recorded to the second buffer when the first buffer is full.

20. The system of claim 13, wherein the display component includes an indicium for accessing the sub-service.

21. The system of claim 13, wherein the digital media content is a multimedia program.

22. The system of claim 13, wherein the sub-service is a web browser application.

23. The system of claim 13, further comprising an input device configured to input the first and second commands.

24. The system of claim 13, wherein the system is included within a mobile electronic device.

25. The system of claim 13, wherein the receiver, the transceiver, the memory, and the processor are included within a set-top terminal.

26. An apparatus for automatically recording digital media content, the apparatus comprising:
a receiver configured to receive a first service including digital media content;
a transceiver, coupled to a processor, the transceiver configured to receive data associated with a second service;
a memory, coupled to the receiver and the processor, the memory configured to automatically record the first service when the second service is accessed;
the processor configured to receive a first command to access the second service and a second command to access the first service; and
an input device configured to input the first and second commands.

27. The apparatus of claim 26, further comprising rendering means configured to render one or more components of the first service and the data associated with the second service.

28. The apparatus of claim 27, wherein the rendering means includes a display component.

29. The apparatus of claim 27, wherein the apparatus is a mobile electronic device.

30. The apparatus of claim 26, wherein the apparatus is a set-top terminal.
